(19) United States
(12) Patent Application Publication
(10) Pub. No.: US 2013/0212038 A1
(43) Pub. Date: Aug. 15, 2013

(54) SERVICE FOR SIGNING DOCUMENTS ELECTRONICALLY

(71) Applicant: Ossi Marko, Helsinki (FI)

(72) Inventor: Ossi Marko, Helsinki (FI)

(73) Assignee: Signom Oy, Helsinki (FI)

(21) Appl. No.: 13/817,758

(22) PCT Filed: Jul. 18, 2011
(86) PCT No.: PCT/FI2011/050661

§ 371 Date: Apr. 23, 2013

(30) Foreign Application Priority Data
Aug. 20, 2010 (FI) 20105866

(51) Int. Cl. G06Q 10/10

(52) U.S. Cl. CPC G06Q 10/10
USPC 705/342

(57) ABSTRACT

A method and a system for preparing legally binding documents and signing them electronically. In the system, identification of the signatories and verification of the right to sign are provided by a strong identification service and a separate association information system. After this, the document is signed by electronic signature and a hash and identification information are stored from the signed document in the memory of the system. Copies of the document are delivered to the signatories and the document is then removed from the server. By the hash, it is possible later to determine whether the document was signed by the other signatory, when the document was signed, whether it has the same content and who signed it.

### FIELD OF THE INVENTION

The invention relates to the preparation of signature versions of contracts and other documents and to their electronic signing in a legally binding manner.

### BACKGROUND OF THE INVENTION

The legal validity of contracts and other documents signed by companies and other associations requires them to be signed by a person having a right to represent that company or other association. Currently, the most typical manner of producing and signing contracts and other documents is to prepare them electronically, then print them on paper, sign by a pen and take them or send them by mail or by other means to be signed by the other parties. Since the signature must be acquired from representative persons who are not physically located in the same place, the signature process often becomes time-consuming and difficult. In addition it is not later possible to confirm who signed the document, because reliably to link a signature made by a pen with .a specific person is challenging. Confirming authorization of the signing persons from information sources maintained by public authorities or by other means also delays the signature process. Other documents to be signed include, in addition to sales and other contracts, for example different minutes of a meeting and other records, application documents, certificates, powers and other equivalent documents which need to be signed and for the legal effect of which the signature is important or which one wants to confirm by signatures for other reason.

To solve the problem, various electronic signature methods have been developed, but they have not, for the present, solved all problems and are not widely used. In addition to electronic signature, the method should make certain that the signing person is exactly the one they claim to be and that in acting as representative for a company or other association they have the right to sign the document in question on behalf of that company or other association. In addition, the system should provide information about which documents have been signed. However, the information should be stored in such a way that only the signatories have the signature copies of the signed documents, and the signature service provides technical means for reviewing the information relating to the signature of the document and the content of the document without the need to store the document in the signature system. Contracts most often contain business secrets important to be kept confidential.

One solution to the present problem is to use a public key infrastructure where each user has their own private and public key. In the public key infrastructure there is, however, the problem that it is difficult for the counterparty to confirm that the provided key belongs to that particular person who is to sign the document. Further, the public key systems are impractical for the reason that they typically require a proper application program for each terminal to be used, in addition to the private key of the user.

### SUMMARY OF THE INVENTION

The present invention describes a method and a system for signing a document electronically. In the method for signing a document electronically, in which method there is at least one signatory for the document, the signatory is (signatories are) identified by a strong identification method, the document to be signed is uploaded to a document server by any of the identified signatories, the document is signed by each of the identified signatories, in which signature step an electronic signature method is used, the right of each identified signatory to represent the specific company or other association is verified from an association information or other database maintained by a public authority in connection with each signature, the signed document is sent to each of the identified signatories. In one preferred embodiment of the invention the rights to sign are stored on the document server for temporary storage, for example in such a way that the signatory's rights to sign are not verified in case the previous verification was performed less than a week ago. The length of the storage period can be freely selected. In one preferred embodiment of the invention the strong identification method is bank identification. However, other strong identification methods may also be used. In one embodiment according to the invention identification information and a hash of the signed document are stored on the document server for archiving. By the hash, it is later possible to confirm whether a specific document has been signed by the system. However, the content of the document cannot be concluded from the hash, so the claimed signed document must be exactly identical.

The system according to the invention for signing a document electronically includes a terminal of a first signatory for processing the document, a terminal of a second signatory for processing the document, a document server, an identification server for identification of the users and the signatories, and an association information server for confirmation of the signatory's right to sign the document. In the present invention, by an association information server is meant a server from which it is possible to verify authorizations to sign the name of different companies, organizations or other legal associations or other rights or information related thereto. In case there are more than one signing party, there are typically several terminals of the signatories, respectively. It is also possible that several signatories use the same terminal to sign the document. The document server of the system according to the present invention is arranged to control the identification server for identification of the signatories, verify the signatories' right to sign from the association information server, receive the signed document from each of the signatories, send the document signed by all of the signatories to all signatories.

In one system according to the present invention the document server is arranged to store the rights to sign on the document server for temporary storage. In one system according to the present invention the identification server is a bank identification server. Furthermore, in one system according to the invention the terminals of the signatories are arranged to use a public key signature method. In one system according to the invention the document server is arranged to store identification information and a hash of the signed document on the document server for archiving.

In the method and the system according to the invention the components of the system are connected by conventional data communication connections. Preferably, the data communication connection to be used is encrypted.

In one embodiment of the present invention the signatory signs several documents simultaneously by a single signature procedure. In this case, the signatory's assistant or other person uploads to the system several documents, which are signed simultaneously by a single signature procedure using the system.

By the method and the system according to the invention described above, it is possible easily, efficiently and reliably to sign legally binding contracts and other documents. The contracting parties know who signed the document and can trust that the parties' rights to sign have been verified. Furthermore, by the system according to the present invention it is possible afterwards to compare the document with the hash stored therefrom. In case one of the signatories later denies having signed the document, the signed document can be compared with the hash stored therefrom, in which case log data of the system show whether the document has been signed by that signatory, when the document has been signed, whether it has the same content and who has signed it.

### LIST OF FIGURES

FIG. 1 illustrates a block diagram of one system according to the invention, and

FIG. 2 illustrates an example of one method according to the invention.

### DETAILED DESCRIPTION OF THE INVENTION

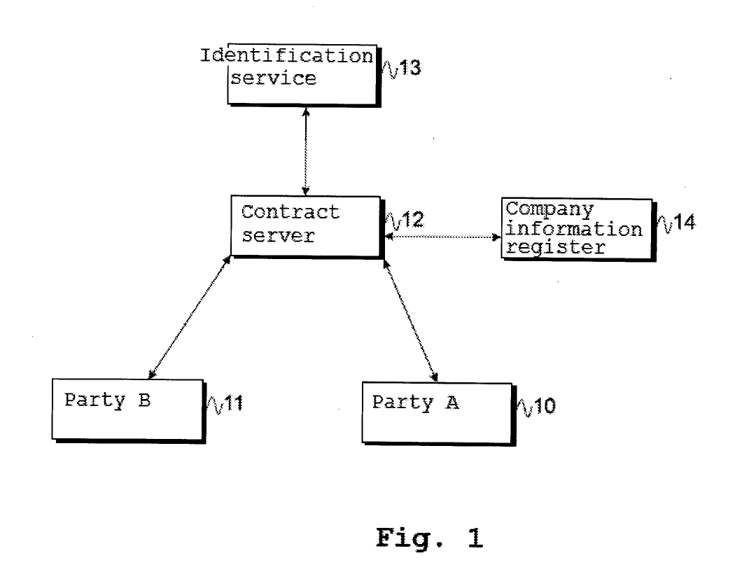

FIG. 1 illustrates one example of the system according to the invention. In the example, signatory A 10 and signatory B 11 are connected to a document server 12. The document server is connected to an identification service 13 and a company information system 14. All these components are connected via a bidirectional information network, for example the Internet. The document parties A and B use a conventional work station, computer or other applicable data processing apparatus to sign the document. The identification service 13 may be any strong identification service that is available. Typically, the identification service is an external server independent of the signature service according to the invention and may include one or more identification servers based on different identification services. Such strong identification services include for example electronic identification systems of different banks, an electronic identity card or modern mobile identification methods. Also, any other system by which the identity of the signatory can be individually verified can be used for identification. In addition to the identification service 13, the system is connected to a company information system 14. From the system, it is possible to verify whether a specific person has a right to sign a specific document and bind thereto the company or other association they represent, i.e. whether that person is authorized to sign the documents on behalf of that company or other association. Since this information is typically subject to charge, it can be stored in the cache of the document server for a specific period. However, in the present example authorization to sign is verified every time.

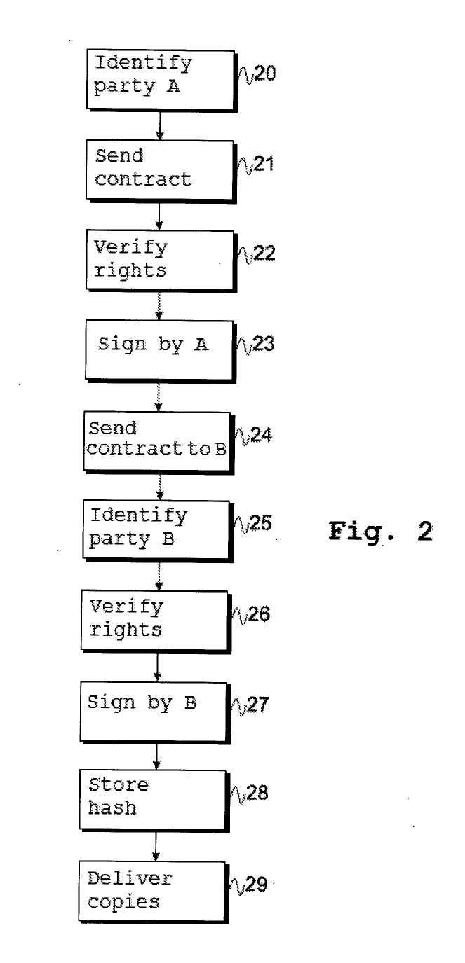

FIG. 2 illustrates one method utilizing the system of FIG. 1. The method according to the example is started by party A logging in the system by identifying themselves using a strong identification service, step 20. After this, party A uploads a document to be signed by B in the system, step 21. Then, A starts a two-step signature process wherein A's rights to sign are first verified, step 22, and after this any signature method known by the person skilled in the art is used, step 23. Then, the contract contains the signature of A. After this, the document is sent to party B, step 24, who starts the corresponding signature process. First, party B is identified using a strong identification service, step 25. After this, the rights of signatory B are verified, step 26, and the document is signed by an electronic signature method, step 27.

At this stage, the document is signed by competent signatories of both parties and thereby becomes legally binding to the parties. After this, the document server stores a hash formed from the content of the document in its database, step 28. On this basis, it is later possible to confirm the form of the document that was signed, and the document text itself need not be stored but can be removed from the document server. In addition to the hash, also other identification information can be stored on the server, such as when the document was signed and who the parties were. However, any such details disclosed in the contract itself need not be attached as identification information to the hash. For example, if the parties in the document want complete confidentiality, it suffices that the contract is given an identification number. The signatories of the document are disclosed in the document copy and are thereby included in the formation of the hash. At the end of the method, the version containing the signatures of both of the parties of the document is delivered to both parties.

In addition to storing the above-mentioned hash, it is also possible to store the actual contract text on the server, in case the customer so desires. In this case, in a preferred embodiment of the invention the contract text can be encrypted in such a way that only the contracting parties can read the contract. However, the encryption is not necessary.

Furthermore, one preferred embodiment according to the invention differs from the method according to FIG. 2 in such a way that several hashes are stored in the system. A first hash or copy of the contract with identification information is stored in the system from an unsigned contract. After this, a second hash or copy of the contract is stored in the system with the signature of the first signatory. Furthermore, a hash or copy of the contract is then stored in the system every time after each new signature, such that proper identification information and a hash are separately lodged in the system from the empty contract and each signature.

Furthermore, in one embodiment according to the invention the uniformity of the content of the document is verified using the hashes in such a way that each signing party uploads the document to be signed in the system, after which the system generates a hash from each uploaded document and compares the hash of the document with the hash of a document uploaded by another party. In the present embodiment the parties signing the document agree on the content of the document and obtain the final version to be signed. After this, it is still possible to review the document and reconsider its signing, yet the content thereof cannot be changed. In case no party changes the document, the hashes formed therefrom are uniform, and the parties can be certain that all have signed versions of the document having the same content. In other words, the content of the document to be signed need not anymore be verified by reading at the signature stage, but the system automatically verifies the uniformity of the content of the documents utilizing the hashes.

Furthermore, in one embodiment according to the invention it is confirmed that the contracts signed by proxy or other authorization are binding to the company or other association on behalf of which the authorized agent signed the document. By a proxy is meant that the holder of authorization has, on the basis of their position, a right to sign contracts or other documents as part of their work specification on behalf of the company or other association they represent. Such proxies are not registered in databases maintained by public authorities, but the authorizations are typically based on the position of that person in the company or other association and may be limited by internal rules determining limits for the authorization. In this case, the signatory's right to represent the specific company or other association cannot be verified from the information of public authority. The content of proxy may vary depending on the size of the company or other association, the signatory's position and their work specification. Since the signatory's right to represent the specific company or other association cannot be verified from the information of public authority and since the limits of competence and authorization given by proxy are open to interpretations, the other party of the contract does not have any possibility beforehand to make sure whether the contract will be legally binding to the company or other association from the part of which the contract was signed by proxy. In the present embodiment the uncertainty factors concerning legal validity possibly associated to proxy are eliminated in such a way that a profile of the signatory is provided with information concerning the types of document they may sign to bind the company or other association, whereby the limits of the power of representation are accurately defined. This information is confirmed in the signature system by a person authorized to sign the name of the specific company or other association registered in the association information system or other public authority databases. The accurate content of the right to represent associated to proxy or other authorization is disclosed at the signature stage to all of the persons signing the document in the document to be signed. In this case, the counterparty signing the document accurately knows the content of the signatory's right to represent the specific company or other association. Since the registered holder of authorization to sign the name of the company or other association has confirmed the limits of this power of representation, the chain of authorization continuously extends from the signatory to the registered holder of authorization, whereby, within these limits, the signed documents are binding to the specific company or other association with certainty. In case the signatory has exceeded the limits of their right to represent disclosed to the other parties in the document to be signed, of which the other parties have thereby become aware, a possible argument concerning validity of the document by the other parties cannot legally succeed in such a situation where the legal requirement would be that the other parties did not know and were not to know that the signatory had exceeded the limits of their right to represent. This avoids conflicts concerning validity of contracts, where it is often difficult to demonstrate whether the other party knew or should have known that the limits of the power of representation were exceeded. The method thereby also provides a risk management mechanism for a company on behalf of which contracts and other documents are being signed by proxy or other authorization, because the procedures exceeding the power of representation as they appear to the outside in the signature stage are not legally binding to the company. The person confirming the content of proxy or other authorization must be a holder of authorization to sign registered in the association information system or other databases maintained by public authority.

Furthermore, in one embodiment of the invention a document processor is connected to the system. The processor is in charge of providing the documents to the system and of their further processing after signature. This procedure is typical when the signatory signs lots of documents such as the holders of authorization to sign and directors of a company or other association. In the current method, the signatory's assistant or other processor prints all electronic documents to be signed on paper and collects the signatures therefor from the holder of authorization to sign the name of the specific company or other association when they are physically present. After this, the assistant sends the signed paper documents separately and individually to all those parties needed to sign the specific document, having to wait that the original documents have circulated through all the signatories. Also in the other companies or other associations signing the document, it is respectively imperative to wait that the holder of authorization to sign is physically present, which slows the signature process and commencement of such contracted business operations where the prerequisite is that a mutually signed and binding contract exists. When the original documents contain all necessary signatures, one of the original copies containing the signatures of all of the parties is one more time sent to each party, after which these paper documents are scanned to the electronic form in order to store them in electronic document management systems, in addition to which the paper originals are also archived in file folders. In the present embodiment the document processor of the company uploads all electronic documents required to be signed to the system along with the names and e-mail addresses of the other signatories of the specific documents. After this, the system sends information to the signatory of the company that all documents uploaded to the system by the company's processor are ready to be signed by the signatory. After this, the signatory of the company can sign all documents by one signature procedure (i.e. “clicking” on the signature button in the system) at a chosen time regardless of time and place, requiring only either fixed or mobile internet connection and a terminal. Then, the system electronically delivers the documents automatically to all other signatories, who are also able to sign the documents as described above regardless of time and place. Finally, the system automatically sends the documents signed by all of the parties electronically to all parties and to the processor or automatically stores them directly to the document management or other information system of the company in the right document file folder. By the method, it is possible to sign a limitless number of documents with different contents on behalf of a company or other association by one signature procedure, which are then sent by the system to the other signatories of each document.

The above-mentioned features can be implemented in the system together or separately because they are not mutually exclusive. In a preferred embodiment of the invention all of the stated features are carried out, but that is not necessary for the functionality of the method.

The invention is not limited merely to the exemplifying embodiments referred to above; instead, many variations are possible within the scope of the inventive idea defined by the claims.

1. A method for signing a document electronically, in which method there is at least one signatory, the method comprising:
identifying the signatory with a strong identification method;
sending the document to be signed to a document server by any of the identified signatories;
signing the document by each of the identified signatories, wherein an electronic signature method is used in the signing step;
verifying, in connection with each signature, the right to sign of each identified signatory signing the document in the name of a company;
sending the signed document to each identified signatory;
wherein the right of the identified signatory to sign the document on behalf of a company or other association is verified from a profile of the signatory confirmed by a holder of authorization to sign the name of the company or other association.

2. The method of according to claim 1, wherein the right to sign are stored on the document server for temporary storage.

3. The method according to claim 1 wherein the strong identification method is bank identification.

4. The method according to claim 1, wherein identification information and a hash of the signed document are stored on the document server for archiving.

5. The method according to claim 5, wherein identification information of the signed document is stored separately after each signature.

6. The method according to claim 1, wherein a number of documents is signed simultaneously.

7. A system for signing a document electronically for performing an action, the system comprising:
a terminal of a first signatory for processing the document;
a document server;
an identification server for identification of the users and signatories; and
an association information server for confirmation of the signatory's right to sign;
to control the identification server for identification of the signatories;
to verify the signatories' right to sign;
to receive the document signed by each of the signatories;
to send the document signed by all signatories to all of the signatories;
wherein the document server is arranged to verify the right of the identified signatory to sign the document on behalf of a company or other association from a profile of the signatory confirmed by a holder of authorization to sign the name of the company or other association.

8. The system according to claim 7, wherein the document server of the system is arranged to store the rights to sign on the document server for temporary storage.

9. The system according to claim 7 wherein the identification server is a bank identification server.

10. The system according to claim 7, wherein the document server is arranged to store identification information and a hash of the signed document on the document server for archiving.

11. The system according to claim 10, wherein the document server is arranged to store identification information of the signed document separately after each signature.

12. The system according to claim 7 wherein the system is arranged to sign several documents simultaneously.
